(19) United States
(12) Patent Application Publication
(10) Pub. No.: US 2002/0174196 A1
(43) Pub. Date: Nov. 21, 2002

(54) Methods and systems for creating a multilingual web application

(76) Inventors: J. Douglas Donohoe, Evergreen, CO (US); Samuel R. Neth, Mountain View, CA (US); Brian D. Zak, San Mateo, CA (US); Tague Griffith, San Francisco, CA (US)

Correspondence Address: Finnegan, Henderson, Farabow,, Garrett & Dunner, L.L.P., 1300 I Street, N.W., Washington, DC, 20005-3315, US

(21) Appl. No.: 10/134,785

(22) Filed: Apr. 30, 2002

Related U.S. Application Data
(60) Provisional application No. 60/287,021, filed on Apr. 30, 2001.

(51) Int. Cl. G06F 15/16

(52) U.S. Cl. 709/219; 709/246

(57) ABSTRACT

A system and method for providing multi-locale and multi-currency applications that may be used by multiple users, each of which submits requests and expects replies in a different language or currency. In one embodiment, a user at a client computer submits a request for information to a server. The server identifies a locale (including attributes such as language) and/or currency (including appropriate format of presentation) to associate with the user, and then constructs a dynamic Web page that contains text in at least one of a plurality of languages and/or currency and other symbols in any one of a plurality of language formats. If the user requests a locale, language or currency format that is not supported, the present system and method will determine a default or alternate response that will closely satisfy the user's request.

### RELATED APPLICATIONS

This application claims priority from the following U.S. Provisional Application, the disclosure of which, including all appendices, is incorporated by reference in its entirety for all purposes: U.S. Provisional Application Serial No. 60/287,021, to J. Douglas Donohoe et al., entitled, “Method for Implementing a Multilingual Webstore,” filed Apr. 30, 2001.

### DESCRIPTION OF THE INVENTION

1. Field of the Invention

The present invention relates to systems and methods for providing information to users over a computer network and, more particularly, to systems and methods for efficiently providing user-specific language and formatted currency information in response to a user request.

2. Background of the Invention

With the development of the Internet and its growing and widespread use, individuals in countries throughout the world can now connect to computer systems anywhere on the global network to request the delivery of information to a client device. This client device may be a computer, a home entertainment console (such as Microsoft's WebTV unit), a personal digital assistant (such as a handheld device from Palm Computing), or a cellular phone. The client may also be any other device capable of connecting to the Internet to submit a request for information and/or receive the information so requested. These client devices often make requests and receive information through the use of a software program running on the device referred to as a web browser (such as Netscape Navigator). The communication may take place using a mechanism known as HTTP (or Hyptertext Transfer Protocol), and the resulting information may be delivered in the form of HTML (or Hypertext Markup Language) documents. Requests may also be submitted in the form of an XML (Extensible Markup Language) document from a cellular telephone, with the resulting information delivered via SMTP (Simple Mail Transfer Protocol) in plain text to the requester's cellular telephone IP (Internet Protocol) address. Requests from a client may additionally be made to a server without the use of the Internet. For instance, requests from the client to a server may be made on the same physical device where the client and server are simply logically separate portions of a single software program.

The client-server model may be extended to what is referred to as a “multi-tier architecture”. In this architecture, a database management system (DBMS) provides services related to storage and retrieval of information. A second software program called an Application Server interprets requests from the client and makes use of the services provided by the DBMS and formulates a response containing the relevant information. The response generally combines predefined static elements (those that are the same for any response of a particular type) with dynamic elements (those that are produced specifically in response to a particular request). These dynamic elements may include information retrieved from the DBMS, or from any number of other sources and subsystems, such as files stored on disk by the server's Operating System (the basic services that support all interaction of software programs with the hardware of the computer). In responding to the user request, the Application Server may construct a reply by executing a “template”, containing a combination of static elements and instructions for incorporating dynamic elements. Many formats for defining templates are known by those skilled in the art, including JSP (Java Server Pages), in which the dynamic elements are incorporated into the response by fragments of software code written in the Java programming language.

When a client transmits a request, the request is received by another software program known as a Web Server, and forwarded to one or more Application Servers as appropriate. The Web Server waits for a response from the Application Server, and then transmits it back to the client device. This combination of the Web Server, Application Server, Database Server, and other related software programs is commonly referred to as a “Web Application”.

Because a Web Application is generally available for interaction with many users at once, and because each user may have different requirements with regard to the language and currency format in which the Web Application's responses should be presented, Web Applications present special challenges. First, each client device may communicate requests and expect replies using a different character set or character encoding. A character set is a standardized set of valid characters that may appear in text represented in the request or response, or in the memory or storage systems of the computer or client device. An example of a character set is the 8859-1 ISO (International Standards Organization) character set for representing Latin-1 or Western languages. This character set includes all of the accented and unaccented roman alphabetic and numeric characters, as well as various widely used punctuation characters. Other character sets may include a wide variety of other characters, such as the Cyrillic characters required to represent text in many eastern European languages, or ideographic and phonetic characters required to represent text in Eastern languages such as Chinese, Japanese, or Korean. A character encoding is a standardized method of representing the characters that make up a character set as a series of bits that are understood by the software programs that make up the Web Application architecture. In order to correctly interpret a request from a client device and produce an intelligible reply, the Web Application must accept a wide variety of relevant character sets and character encodings from each client device, and then return a response that is consistent with the decoded information.

A second major challenge with Web Applications that must support multiple languages and currency formats arises from the desire to produce responses for many clients using the same “templates”, in order to minimize the programming effort required to support multiple languages. In the prior art, individual templates designed to produce a response in a particular language were required. Every time a new language was added, a programmer had to create a new template, or include programming logic that explicitly handled the determination of which output to produce depending on the appropriate language and/or currency.

A third challenge affecting multi-lingual and multi-currency Web Applications is the inability of the applications to respond to user requests when the user requests a language or currency format that is not supported by the system. In the prior art, if a response could not be produced in accordance with the language or currency requested by the user, the result was an incomplete response, or a response indicating the request could not be processed.

### SUMMARY OF THE INVENTION

Systems and methods consistent with the present invention satisfy the above-described need by providing a system and method for providing multi-locale and multi-currency applications that may be used by multiple users, each of which submits requests and expects replies in a different language or currency. In one embodiment, a user at a client computer submits a request for information to a server. The server identifies a locale (language) to associate with the user, and then constructs a dynamic Web page that contains text in at least one of a plurality languages and may contain currency and other symbols in any one of a plurality of formats. If the user requests a locale, language or currency format that is not supported, the present system and method will determine a default or alternate response that will closely satisfy the user's request.

Additional benefits of the invention will be set forth in part in the description which follows, and in part will be obvious from the description, or may be learned by practice of the invention. The benefits of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention. In the drawings,

FIG. 1 is a block diagram depicting an illustrative system in which the present invention may be practiced;

FIG. 2 is block diagram depicting the operation and interfaces of one embodiment of the present invention;

FIG. 3 is a block diagram depicting the structure of a database in accordance with one embodiment of the present invention; and

FIG. 4 is a flow diagram of a method for retrieving information from the Internet in accordance with one exemplary embodiment of the present invention; and

FIG. 5 is a block diagram depicting the contents of a template in accordance with one exemplary embodiment of the present invention.

### DETAILED DESCRIPTION

In the following detailed description of the preferred embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc. which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

Referring now to the drawings, in which like numerals represent like elements throughout the several figures, the present invention will be described.

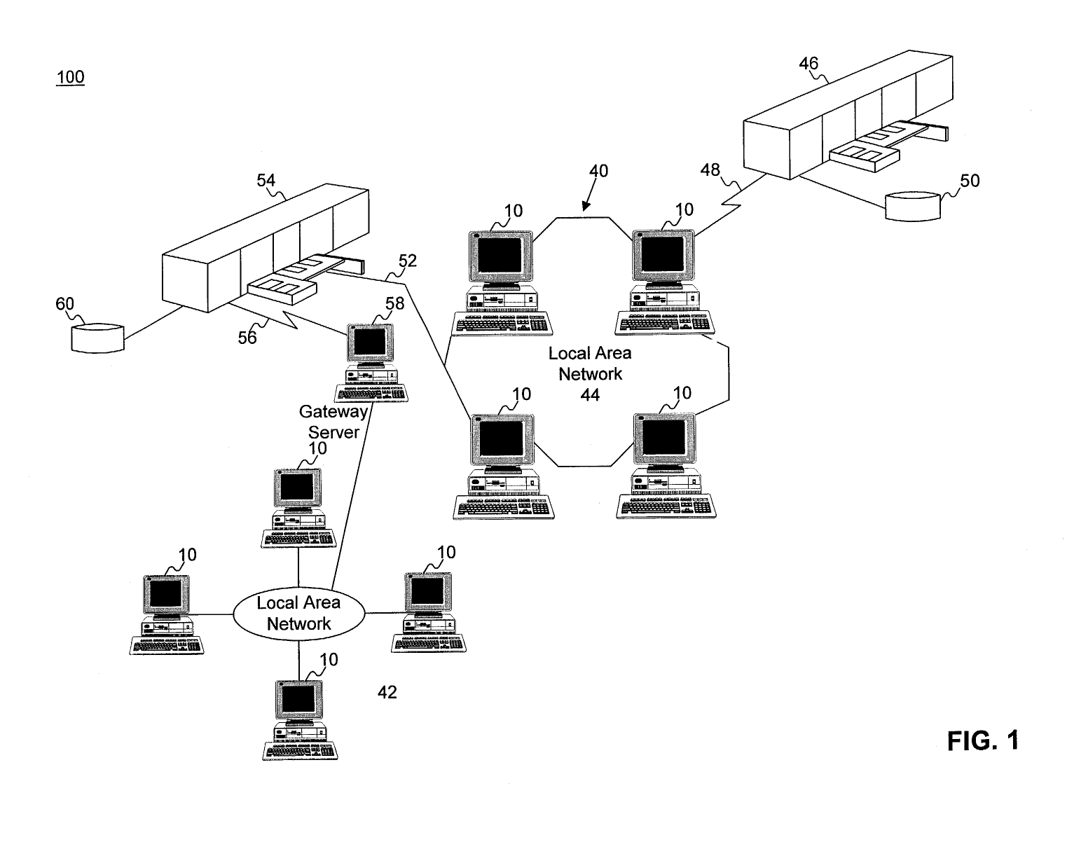

FIG. 1 illustrates a data processing network 100 in which the present invention may be practiced. The data processing network 100 includes a plurality of individual networks, including LANs 42 and 44, each of which includes a plurality of individual workstations 10. Alternatively, as those skilled in the art will appreciate, a LAN may comprise a plurality of intelligent workstations coupled to a host processor. LAN 44 may be coupled to a communications link 52 or a gateway server 58. The gateway server 58 is preferably an individual computer or intelligent workstation which serves to link the LAN 42 to the LAN 44. Data processing network 100 may also include multiple servers, such as a server computers 46 and 54. Server computers 46 and 54 may be preferably coupled to the LAN 44 and LAN 42, respectively, by communications links 48 and 56, respectively. Server computers 46 and 54 may also be coupled to storage devices 50 and 60, respectively, which may serve as remote storage for LANs 44 and 42, respectively. In one embodiment, storage device 50 may store records associated with a retailer's product information and storage device 60 may store records associated with customer data.

Those skilled in the art will appreciate that the server computer 46 may be located a great geographic distance from the LAN 44, and similarly, the LAN 44 may be located a substantial distance from the LAN 42. For example, the LAN 42 may be located in Washington, D.C., while the LAN 44 may be located in Palo Alto, Calif., and the server computer 46 may be located in Germany.

A system in accordance with the present invention, comprises a plurality of workstations 10 and associated servers. The servers may be generally similar to the workstations 10 including a central processing unit, display device, memory and operator input device. Moreover, it will be appreciated that workstation 10 may also perform operations described herein as being performed by a server, and similarly a server may also perform operations described herein as being performed by workstation 10. The distributed system may comprise any one of a number of types of networks over which workstations and servers communicate, including LANs, wide area networks (WANs), the Internet and any other networks that distribute processing and share data among a plurality of nodes. All of these configurations, as well as the appropriate communications hardware and software, are known in the art.

In one embodiment, the present invention is implemented as a computer software program. This program will be used where software application(s) running on a Web server respond to a user's request, perform processing that results in dynamically-generated content being placed in the response, and format the data to be returned to the user. According to the present invention, the user's behavior when accessing the application(s) on the server is monitored and recorded. The implementation of the logic for performing the monitoring and recording function may be integrated with the code of the server application, as one or more modules (also referred to as code subroutines, or “objects” in object-oriented programming) which are invoked during execution of the server application. Alternatively, the logic may be implemented as a separate utility program, which provides services that are accessed by the server application. The implementation will typically execute on a computer functioning as a Web server, where that Web server provides services in response to requests from a client using a Web browser connected to the Internet. Alternatively, the connection may be to a corporate intranet or extranet (that is, a network owned or managed by the user's company or another company, respectively) of which the user's computer is a component, where this corporate intranet or extranet provides services in a similar manner to the Internet. Use of the term “Internet” herein, when discussing processing associated with the user's request, includes processing that occurs in an intranet or extranet, unless otherwise stated. Client requests will typically be sent to the host server using the HTTP protocol. However, because the present invention operates independently of the mechanism used to fetch the data, other protocols such as FTP (File Transfer Protocol), Gopher, etc., may also be used without deviating from the inventive concepts defined herein.

In one embodiment, software programming code which embodies the present invention is accessed by workstation 10 from a storage media of some type, such as a CD-ROM drive or hard drive. In a client-server environment, such software programming code may be stored with storage associated with a server. The software programming code may be embodied on any of a variety of known media for use with a data processing system, such as a diskette, hard drive, or CD-ROM. The code may be distributed on such media, or may be distributed to users from the memory or storage of one computer system over a network of some type to other computer systems for use by users of such other systems. The programming code may alternatively be embodied in memory internal to workstation 10. The techniques and methods for embodying software programming code in memory, on physical media, and/or distributing software code via networks are well known and will not be further discussed herein.

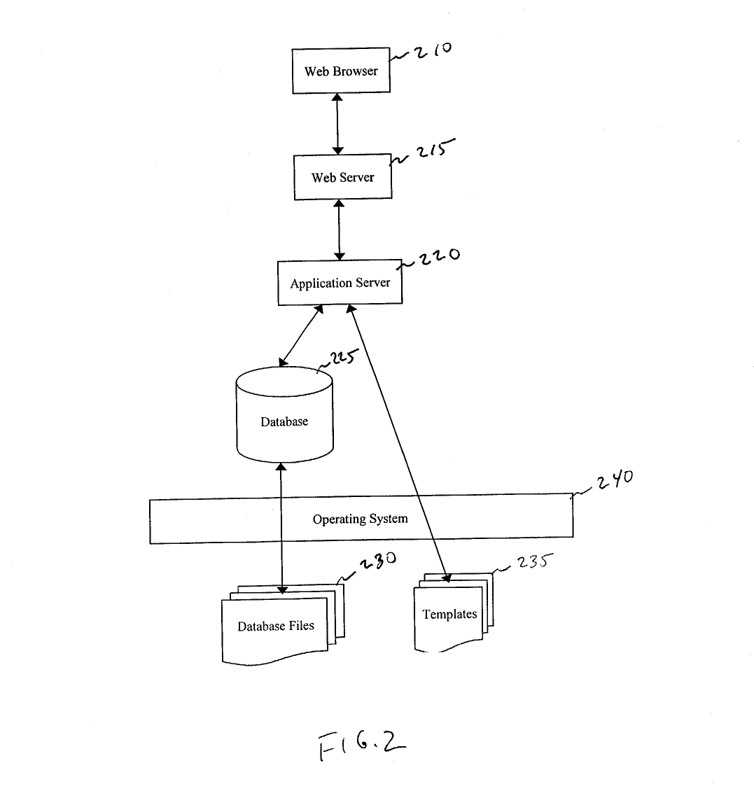

Referring to FIG. 2, there is shown a block diagram of the operation and interfaces of an exemplary embodiment of the present invention. As shown, the operating environment 200 of the present invention includes a Web browser 210, a Web server 215, an Application server 220, a database 225, database files 230, templates 235, and an operating system 240. At its basic level of operation, Web browser 210 permits a user to connect to a given network site, and download informational content from that site, such as an HTML document, for display at the user's computer. When a client transmits a request, the request is received by Web server 215, and forwarded to one or more Application Servers 220 as appropriate. Application Server 220 makes use of the services provided by database 225 and formulates a response containing the relevant information. The response generally combines predefined static elements (those that are the same for any response of a particular type) with dynamic elements (those that are produced specifically in response to a particular request). These dynamic elements may include information retrieved from database 225, or from any number of other sources and subsystems, such as files stored on magnetic disks by the server's Operating System 240. In the embodiment described herein, Application Server 220 may construct this reply by executing a “template”. The architecture depicted in FIG. 2 is intended to merely provide an example of a representative architecture that may be used in connection with the present invention, and is not essential to the current invention.

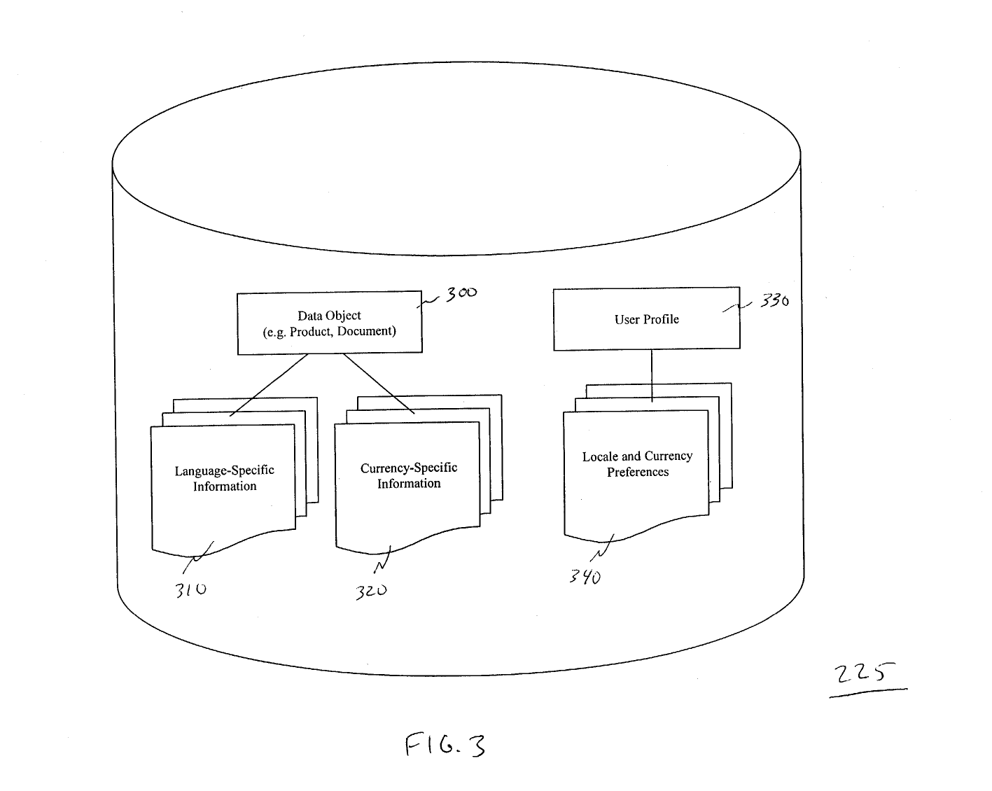

The structure of database 225 will now be explained in FIG. 3. As shown, database 225 contains at least five types of records: Data object 300, locale-specific information 310, currency-specific information 320, user profile 330, and locale and currency preferences 340. Data Object 300 is a product description or other document that may reference locale-specific information 310, or currency-specific information 320. More specifically, data object 300 may be a catalog description of an item available from an online merchant. Locale-specific information 310 contains a plurality of languages, dialects and associated translations of text that are to be merged with a template 235 prior to transmitting the template to the user for display.

For the purposes of this invention, the combination of language, dialect, and formatting settings (such as date/number) comprises a “locale”. To accommodate the large number of languages and dialects, the present system uses a subset of the JAVA locale naming scheme: a two-letter ISO language code followed by a two letter ISO country code with an underscore separating the two fields. For example, “fr_FR” represents French as spoken in France, while “fr_CA” represents French as spoken in Canada. Currency-specific information 320, on the other hand, contains formatting and currency conversion factors for a plurality of currencies. In one embodiment, locale-specific information 310 and currency-specific information 320 are formatted records that may be easily inputted and changed by a Web administrator such that no programmer assistance is necessary when adding/deleting locales to/from the present system.

In one exemplary embodiment, a user's locale or currency may be determined based on any of a plurality of factors including: internet protocol (IP) address, geographic location of the client device, the user's expressed preference, etc. For example, linked to each user profile 330, as further shown in FIG. 3, may be a plurality of locale and currency preferences 340. In one exemplary embodiment, a user's locale and currency preference may indicate one or more locales (including formats and language settings) and currencies. For instance, a user for whom fr_FR (i.e., France) is the indicated locale would expect dates to be displayed or entered in the dd-mm-yyyy format (e.g. 25-12-2002), whereas a user for whom fr_CA (i.e., French-speaking Canada) is the indicated locale would expect dates to be displayed or entered in the mm-dd-yyyy format (e.g. 12-25-2002). Note that the appropriate display format for numbers and dates for a given locale may not correlate directly to the language for that locale. In addition, different locales may use different dialects of a given language, in which case different text may be appropriate. For currencies, a similar principle applies, where each currency code may be associated with appropriate settings for precision (the number of decimal places to be displayed), a currency symbol, and whether the currency symbol should appear to the left or the right of the numerical value.

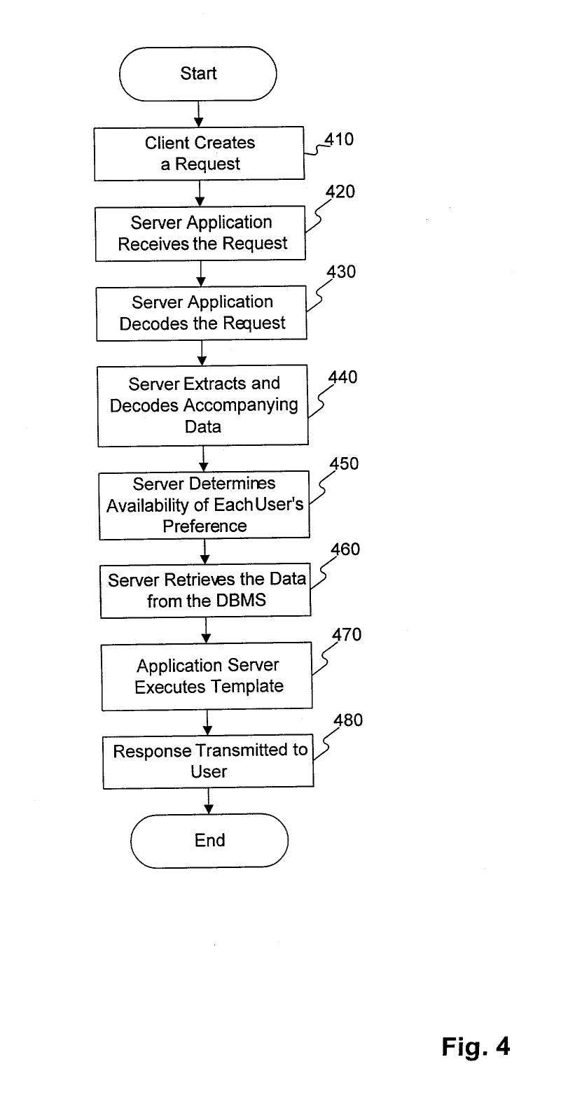

Referring now to FIG. 4, there is shown a flowchart performed by the present invention to satisfy user requests. As shown in step 410, the process begins when a user at client computer 10 creates a request using browser 210 and sends the request to Web server 215 for processing. When the request reaches an application server 220 capable of fulfilling the request, an application operating on the server receives the request and performs processing that dynamically generates Web page content. More specifically, when application server 220 receives the request (step 420), it accesses database 225 to determine the user's locale and currency preference. In determining a user's local and currency preference, the present invention may evaluate the IP address of the client device (which may be used to infer geographic location). Alternately, the determination of user preference may be dependent on a user profile which may be recalled when the user is identified. Identification may take place implicitly (e.g., through receipt of a “cookie” from the client device previously issued for that purpose), or explicitly (e.g., by the user's providing. This identification may also take place explicitly, such as when the user provides a user name and password to log in to the system.

After identifying the user, processing flows to step 430 where the server application explicitly or implicitly decodes the request based on the user's preferences. Once the user's request is decoded, processing flows to step 440 where the server extracts and decodes any data that accompanied the request. For example, if an application operating on the client device requested the user's birthday (without providing a preferred format for the response) the present invention would decode the response in accordance with customs and conventions of the locale identified as described above.

After the user's preferences have been determined and their requests decoded, processing flows to step 450 where the server determines the availability of each user's preference prior to preparing a response to the user's request. If the locale and/or currency that satisfies the user's request cannot be found, the present invention will select another language/currency to be displayed on the user's device. In one exemplary embodiment, the language (or currency format) in which the response is produced will be an alternate language (or currency format) most likely to be of use to the user. In another exemplary embodiment, a “default” language (or currency format) would be specified, such that any information required in a language for which no value were available would be produced in the “default” language. A similar principle applies to the selection of currencies.

The next step is to retrieve the data from the database management system or other data source in a manner that implicitly honors the preferences of the user for which a response is being produced (step 460). In one embodiment of this invention, a piece of displayable text or a monetary value is stored in the database management system in association with a “key” that is used to identify the data for a particular purpose. This “key” consists of a piece of information indicating the purpose of the data, and a second piece of information that indicates the language or currency with which the data is associated. A template that produces the response to a user request invokes an API (Application Programming Interface) by providing the first part of the key. The API combines this piece of information with the user's preference and looks up the appropriate piece of data for inclusion in the response. If the data is not available in accordance with the user's preferences, the API tries again to retrieve it using an alternate or default language or currency. The present invention as described, can easily support explicit references to locales or currencies (such as would be required to display a price in two currencies on the same page, or to display a description in two languages at once). As a result, the designer of the template may ignore the distinctions between languages and currencies and simply create a single template to handle all conceivable possibilities. Once application server 220 retrieves the data from database 225, it executes the retrieved template (step 470). In this step, application server 220 simply combines the identified language and currency specific information into a user-readable response. Next, processing flows to step 480 and the response is sent back to the user at client computer 10.

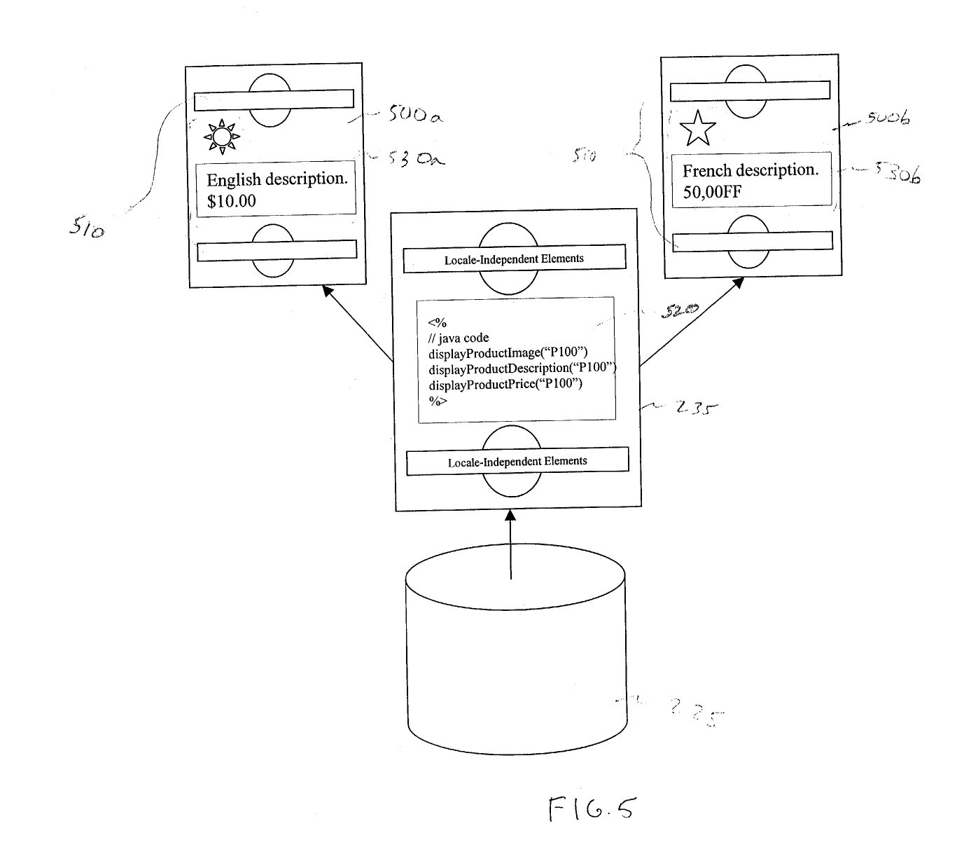

Referring to FIG. 5, there is shown a block diagram depicting the contents of template 235 and the relationship between templates 235 and user-readable responses 500a and 500b. As shown template 235 is comprised of static portions 510 and localized portions 520. The static portions do not change when template 235 is executed. Localized portions 520, on the other hand, are APIs that access database 235 and retrieve the appropriate text, currency, graphics, etc., depending on the users' preferences. User-readable responses 500a and 500b are in turn, comprised of static portions from template 235 and translated portions 530a and 530b. Static portions 510 are identical to static portions from template 235, while translated portions 530a and 530b are text, currency, graphics, etc. portions retrieved from database 235 (via application server 220) that satisfy the user's request for translated text.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

From the foregoing description, it will be appreciated that the present invention provides an efficient system and method for providing a multilingual Web application. The present invention has been described in relation to particular embodiments which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Although aspects of the present invention are described as being stored in memory, one skilled in the art will appreciate that these aspects can also be stored on or read from other types of computer-readable media, such as secondary storage devices, like hard disks, floppy disks, or CD-ROMs; or other forms of RAM or ROM. Similarly, the method of the present invention may conveniently be implemented in program modules that are based upon the flow charts in FIG. 4. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems which may be used in practicing the instant invention and therefore no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

What is claimed is:

1. A method for displaying localized information to a user, the method comprising:
receiving a request for information from a client;
determining at least one of a plurality of user locales from the request;
retrieving a template in response to the request, said template comprising at least one dynamic portion;
executing the template to retrieve information associated with the dynamic portion; and
generating a response to the request, said response comprising the retrieved information presented in a format appropriate to the at least one of a plurality of user locales.

2. The method of claim 1, wherein the response further comprises pricing or other currency-related information presented in a format appropriate to the at least one of a plurality of user locales.

3. The method of claim 1, wherein the response further comprises text presented in a language appropriate to the at least one of a plurality of user locales.

4. The method of claim 1, wherein the response further comprises graphics appropriate to the at least one of a plurality of user locales.

5. The method of claim 1, wherein the generating step further comprises:
generating a response based on an alternate locale when at least a portion of the information requested is not available for at least one of a plurality of user locales.

6. The method of claim 5 wherein the alternate locale is a default locale.

7. A method for displaying pricing or other currency-related information to a user, the method comprising:
receiving a request for information from a client;
determining at least one of a plurality of user currencies from the request;
retrieving a template in response to the request, said template comprising at least one dynamic portion;
executing the template to retrieve information associated with the dynamic portion; and
generating a response to the request, said response comprising the retrieved information presented in a format appropriate to the at least one of a plurality of user currencies.

8. The method of claim 7, wherein the generating step further comprises:
generating a response based on an alternate currency when at least a portion of the information requested is not available for at least one of a plurality of user currencies.

9. The method of claim 8 wherein the alternate currency is a default currency.

10. A method for interpreting information input by a user, the method comprising:
receiving information from a user;
determining at least one of a plurality of user locales from the information; and
decoding the information based on character encoding associated with the at least one of a plurality of user locales.

11. The method of claim 10, wherein the information input by the user is a calendar date.

12. The method of claim 10, wherein the information input by the user is a numeric value.

13. The method of claim 10, further comprising the step of parsing the information using a format appropriate to the at least one of a plurality of user locales.

14. The method of claim 13, wherein the information input by the user is a calendar date.

15. The method of claim 13, wherein the information input by the user is a numeric value.
